(19) United States
(12) Patent Application Publication
(10) Pub. No.: US 2022/0393323 A1
(43) Pub. Date: Dec. 8, 2022

(54) MANUFACTURING METHOD OF LITHIUM BATTERY CELL

(71) Applicant: AMITA TECHNOLOGIES INC., Taoyuan City (TW)

(72) Inventors: Chueh-Yu KO, Taoyuan City (TW); Chiang-Ping CHEN, Taoyuan City (TW)

(21) Appl. No.: 17/339,822

(22) Filed: Jun. 4, 2021

(51) Int. Cl. H01M 50/636; H01M 10/0585; H01M 10/052

(52) U.S. Cl. CPC H01M 50/636; H01M 10/0585; H01M 10/052

(57) ABSTRACT

A manufacturing method of a lithium battery cell is provided and has steps of providing an bag, electrode sheets and a conduit, a part of an edge of the bag being pressed to form an sealing edge, an electrode chamber being enclosed in the bag, the electrode sheet being accommodated in the electrode chamber, the sealing edge being strip-shaped and an air chamber being formed therein, the air chamber being communicated to the electrode chamber, the conduit being disposed on the sealing edge, two ends of the conduit being an inner end and an outer end, the inner end being communicated to the air chamber and separated from the electrode chamber, and the outer end being exposed from the bag; injecting an electrolyte into the electrode chamber through the conduit; pressing the air chamber to form a secondary sealing edge; cutting the secondary sealing edge to remove the conduit.

### BACKGROUND OF THE DISCLOSURE

### Field of the Disclosure

The technical field relates to a manufacturing method of a lithium battery cell, and in particular, to a manufacturing method of a soft pack lithium battery cell.

### Description of Related Art

The related-art manufacturing method of a lithium battery cell generally includes the following steps: first, a stack of electrodes is disposed into a seal bag, and the circumferential edge of the seal bag is sealed, followed by extracting the air inside the seal bag; next, an electrolyte is injected into the seal bag. The aforementioned manufacturing method can be achieved by reserving a hole on the circumferential edge of the seal bag for air extraction and filling of the electrolyte. However, such manufacturing method has the drawbacks of leakage at the sealing edge due to the control and manufacturing difficulties of the hole during the production process.

Another related-art manufacturing method is to place the electrodes and the electrolyte into a relatively larger seal bag, and then position the electrodes and the electrolyte at one side the seal bag, followed by sealing the seal bag. Next, air is injected into another side of the seal bag, and the transverse hot sealing method is used to isolate the air and the electrodes in different spaces, followed by cutting off the portion of the seal bag containing air. Such type of manufacturing method requires the disposal of excessive electrolyte and seal bag waste materials. Consequently, the material cost is increased and additional cost for the processing of toxic waste material is also required.

In view of the above, the inventor of this disclosure seeks to overcome the aforementioned drawbacks through extensive research in conjunction with the theoretical applications. Accordingly, the goal of the inventor of this disclosure is to solve the problem mentioned above with an improved solution.

### SUMMARY OF THE DISCLOSURE

This disclosure provides a manufacturing method of a soft pack lithium battery cell.

This disclosure provides a manufacturing method of a lithium battery cell, including the steps of:

providing an outer bag, a plurality of electrode plates and a conduit; at least a portion of an edge of the outer bag being pressed to form a sealing edge and to form an electrode chamber on an inner circumference of the outer bag; the plurality of electrodes being accommodated inside the electrode chamber; the sealing edge being in a strip shape and an air chamber being formed therein, and the air chamber being fluidly communicated to the electrode chamber; a conduit being disposed on the sealing edge, and two ends of the conduit being an inner end and an outer end; the inner end being fluidly communicated to the air chamber, and a gap being disposed between the air chamber and the electrode chamber, and the outer end being exposed from the outer bag; injecting an electrolyte into the electrode chamber via the conduit; pressing the air chamber to form a secondary sealing edge; and cutting the secondary sealing edge to remove the conduit.

According to the manufacturing method of the lithium battery cell of this disclosure, the inner end of the conduit is connected to an edge of the air chamber. The air chamber is in a conical shape with a pointed end and a blunt end; the blunt end is connected to the electrode chamber, and the pointed end is connected to the conduit. The pointed end of the air chamber is connected to the inner end of the conduit. A separation is formed between the air chamber and an outer edge of the sealing edge. The sealing edge includes an air chamber sealing edge formed between the air chamber and an outer edge of the sealing edge, and the conduit is disposed inside the air chamber sealing edge.

According to the manufacturing method of the lithium battery cell of this disclosure, the method further includes a step of extracting an air inside the electrode chamber via the conduit. The outer end of the conduit is connected to a negative pressure device to extract the air inside the electrode chamber.

According to the manufacturing method of the lithium battery cell of this disclosure, the outer end of the conduit is connected to a fluid injection device to inject the electrolyte into the electrode chamber.

According to the manufacturing method of the lithium battery cell of this disclosure, the conduit is disposed at an external of the secondary sealing edge.

The manufacturing method of the lithium battery cell of this disclosure utilizes the conduit to easily perform air extraction and fluid injection. In addition, the air chamber is sealed to have a secondary sealing edge such that the conduit can be removed from the sealing edge completely. Consequently, the sealing edge may be formed to have a uniform structure without any combination or connection of different structures. Accordingly, no slits or gaps are formed between different structures during the folding of the sealing edge.

### BRIEF DESCRIPTION OF DRAWINGS

FIG. 1 is a flow chart illustrating the manufacturing method of a lithium battery cell according to an exemplary embodiment of this disclosure;

FIG. 2 is a schematic view showing a battery cell semi-product manufactured according to an exemplary embodiment of the manufacturing method of the lithium battery cell of this disclosure;

FIG. 3 is a schematic view showing another example of a battery cell semi-product manufactured according to an exemplary embodiment of the manufacturing method of the lithium battery cell of this disclosure;

FIG. 4 is a schematic view illustrating the air extraction step in an exemplary embodiment of the manufacturing method of the lithium battery cell of this disclosure;

FIG. 5 is a schematic view illustrating the electrolyte injection step in an exemplary embodiment of the manufacturing method of the lithium battery cell of this disclosure;

FIG. 6 is a schematic view illustrating the sealing step in an exemplary embodiment of the manufacturing method of the lithium battery cell of this disclosure;

FIG. 7 is a schematic view illustrating another example of the sealing step in an exemplary embodiment of the manufacturing method of the lithium battery cell of this disclosure;

FIG. 8 is a schematic view illustrating the edge cutting step in an exemplary embodiment of the manufacturing method of the lithium battery cell of this disclosure; and

FIG. 9 is a schematic view showing a lithium battery cell manufactured according to an exemplary embodiment of the manufacturing method of the lithium battery cell of this disclosure.

### DETAILED DESCRIPTION OF THE DISCLOSURE

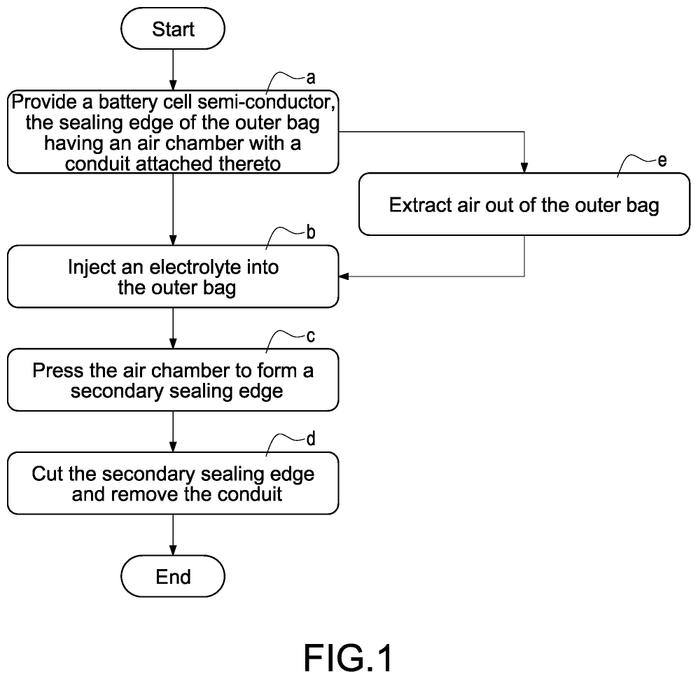

As shown in FIG. 1, according to an exemplary embodiment of this disclosure, a manufacturing method of a lithium battery cell, includes the following steps.

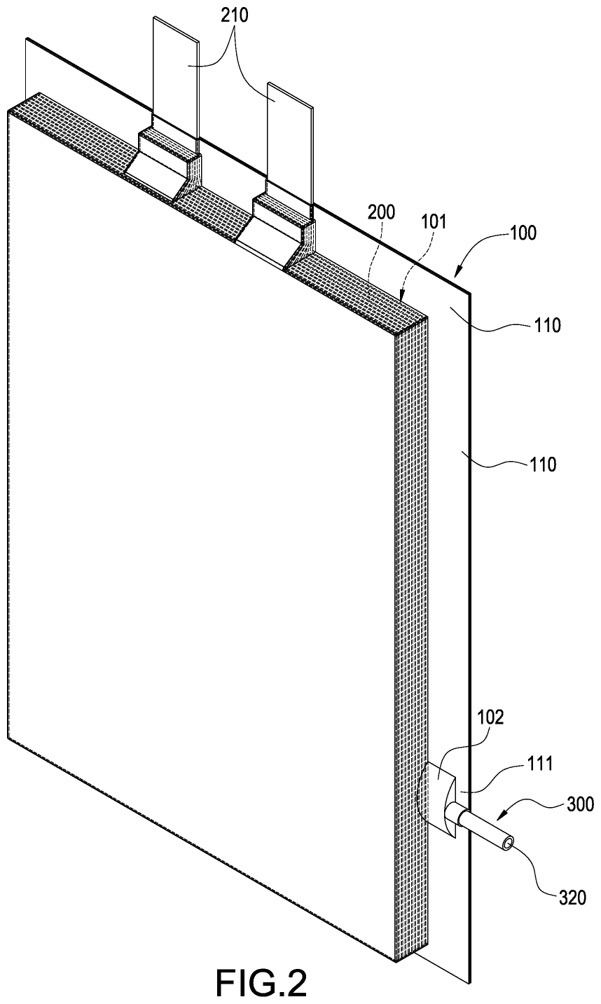

Please refer to FIG. 1 and FIG. 2. First, in step a), a battery cell semi-product is provided, and the battery cell semi-product includes an outer bag 100, a plurality of electrode plates 200 and a conduit 300.

At least a portion of the edge of the outer bag 100 is pressed to form a sealing edge 110. In an exemplary embodiment, the edge of the outer bag 100 is in rectangular shape and includes four sides, and at least two sides of the edge are connected to each other to form the sealing edge 110. In another exemplary embodiment, the four sides of the edge of the outer bag 100 are connected to each other to form the sealing edge 110. In addition, the sealing edge 110 is in a strip shape and forms an electrode chamber 101 on the inner circumference of the outer bag 100. A part inside the sealing edge 110 is not pressed such that an air chamber 102 is formed, and the air chamber 102 is fluidly communicated to the electrode chamber 101. To be more specific, the sealing edge 110 includes an air chamber sealing 111 between the air chamber 102 and the outer edge of the sealing edge 110. With the air chamber sealing edge 111, a separation between the air chamber 102 and the outer edge of the sealing edge 110 is formed.

The electrode plates 200 are stacked onto each other, and the stacked electrode plates 200 are accommodated in the electrode chamber 101. The stacked electrode plates 200 include a pair of electrode tabs 210, and each electrode plate 200 is connected to the corresponding electrode tabs 210. Each electrode tabs 210 is clamped by the sealing edge 110 of the outer bag 100 and protrudes out of the outer bag 100. In some embodiments, the pair of electrode tabs 210 are arranged on the same side of the edge of the outer bag 100. In addition, the air chamber 102 and the pair of electrode tabs 210 are arranged on different sides of the edge of the outer bag 100 respectively.

The conduit 300 is clamped by the sealing edge 110, and two ends of the conduit 300 are an inner end 310 and an outer end 320 respectively. The inner end 310 is fluidly communicated to the air chamber 102, and a gap is formed between the air chamber 102 and the electrode chamber 101. The outer end 320 is exposed from the outer bag 100. To be more specific, the conduit 300 is clamped by the air chamber sealing edge 111, and the inner end 310 of the conduit 300 is connected to the edge of the air chamber 102. Moreover, the inner end 310 of the conduit 300 may also be configured to penetrate into the air chamber 102. A gap is still required to be formed between the inner end 310 of the conduit 300 and the electrode chamber 101.

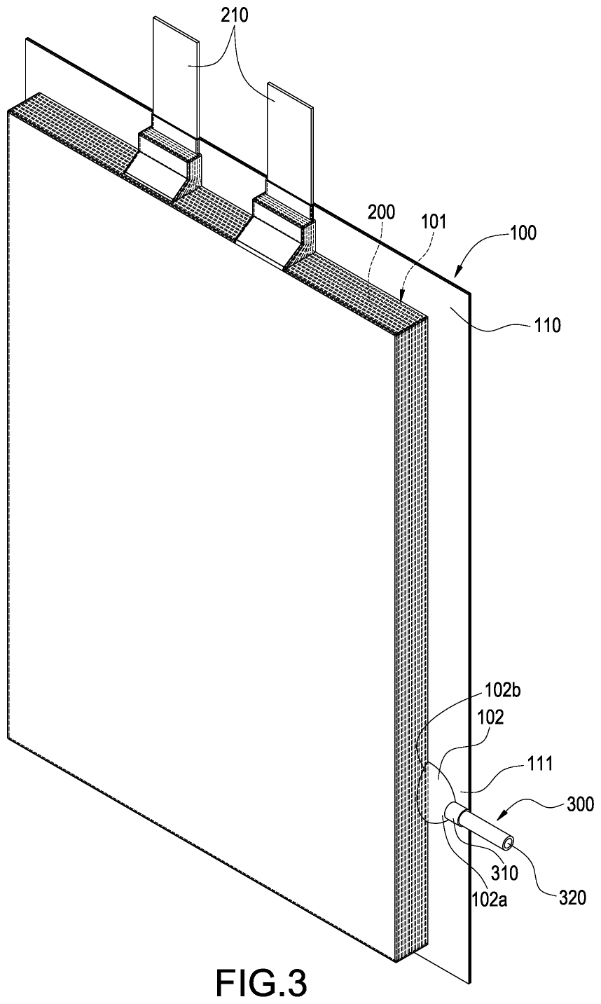

As shown in FIG. 3, this disclosure is not limited to any specific shape of the air chamber 102. In an exemplary embodiment, the air chamber 102 is in a conical shape and includes a pointed end 102a and a blunt end 102b. The blunt end 102b of the air chamber 102 is connected to the electrode chamber 101, and the pointed end 102a of the air chamber 102 is connected to the inner end 310 of the conduit 300. Accordingly, the flow resistance generated due to the shape of the air chamber 102 may be reduced during the air extraction and fluid injection processes. Furthermore, it is also able to avoid the formation of dead corners inside the air chamber 102, thereby preventing any electrolyte residual to be left inside such dead corners of air chamber 102.

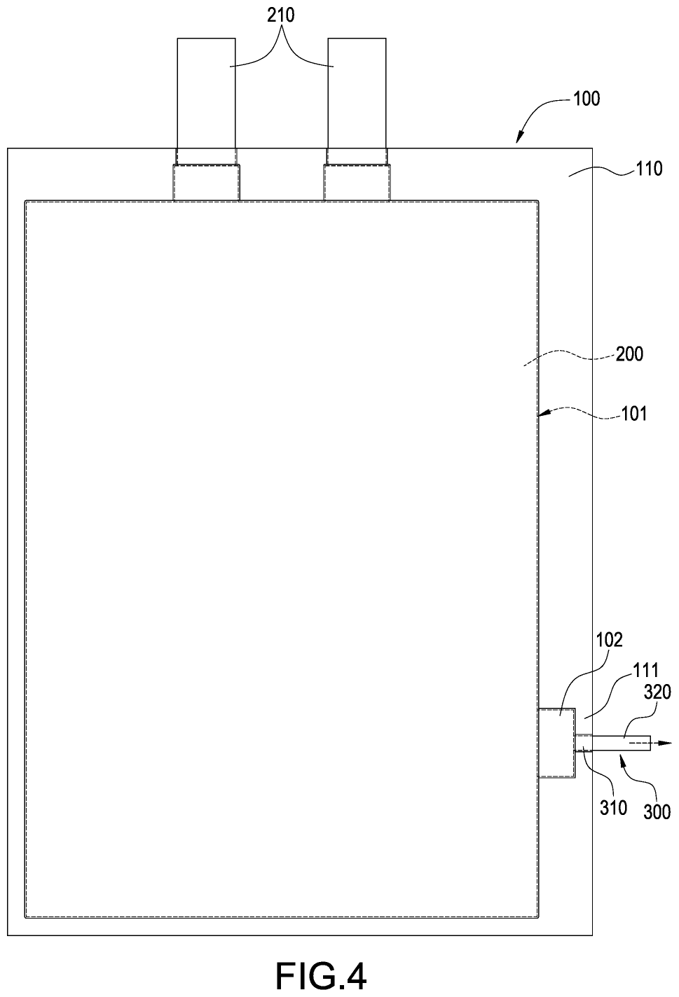

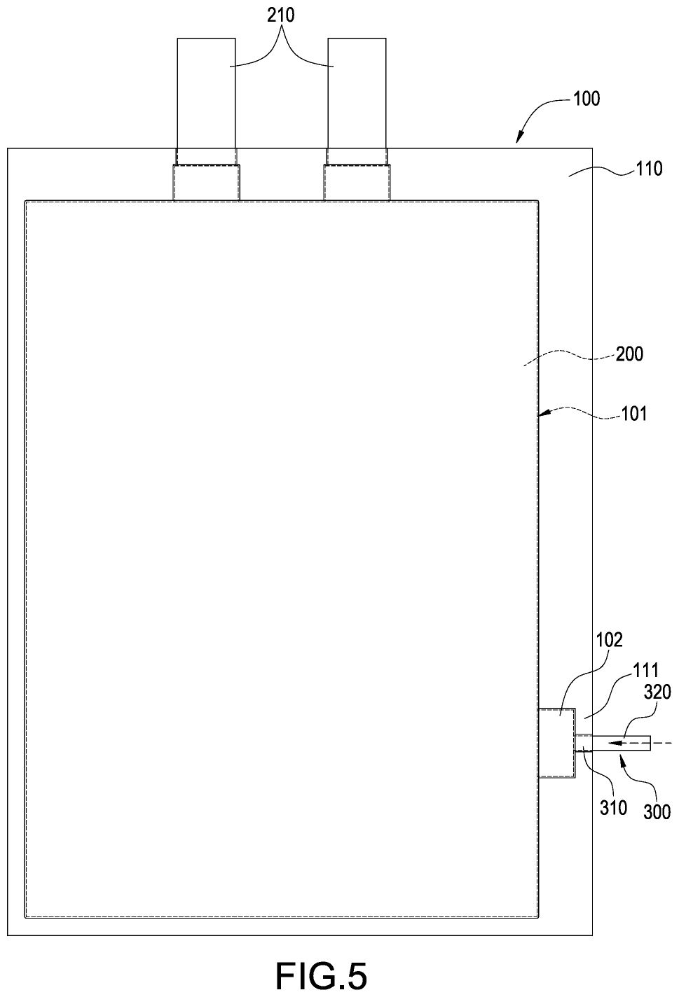

Please refer to FIG. 1, FIG. 4, and FIG. 5. After the step a), in a fluid injection step b), an electrolyte is injected into the electrode chamber 101. In an exemplary embodiment, an air extraction step e) may be further performed between the step a) and step b). In step e), air inside the electrode chamber 101 is extracted via the conduit 300. In step e), the outer end 320 of the conduit 300 is connected to a negative pressure device (not show in the figures) to extract the air inside the electrode chamber 101. This disclosure is not limited to any specific type of negative pressure device, and the negative pressure device may be, for example, an air pump or a bucket pump, capable of generating an air pressure difference. In step b), the outer end 320 of the conduit 300 is connected to a fluid injection device (not shown in the figures) to inject the electrolyte into the electrode chamber 101. This disclosure is not limited to any specific type of fluid injection device, and it may be a fluid pump with its pipe connected to the conduit 300 for delivering the electrolyte via pumping.

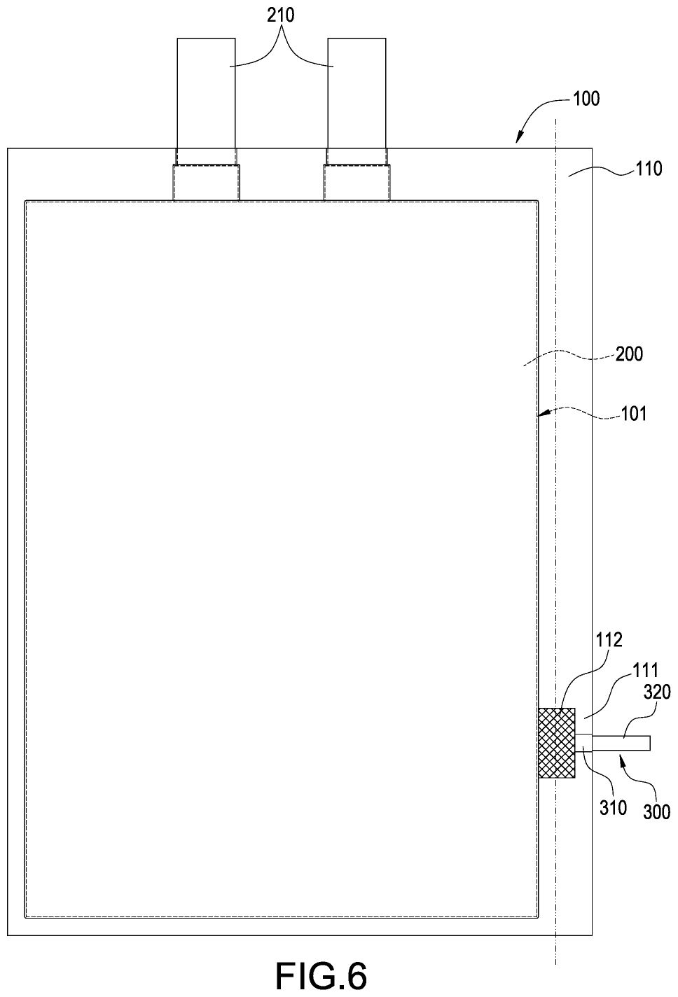

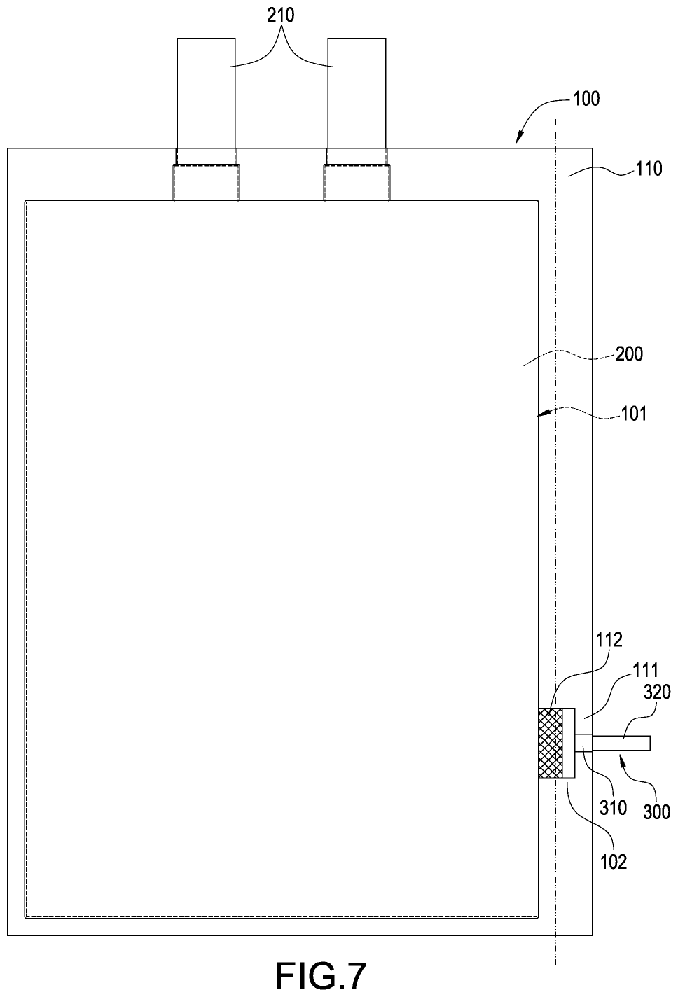

Please refer to FIG. 1 and FIG. 6. After the step b), in a sealing step c), the air chamber 102 is hot pressed to form a secondary sealing edge 112. In an exemplary embodiment, the inner end 310 of the conduit 300 is connected to the edge of the air chamber 102. Therefore, the conduit 300 is located outside the secondary sealing edge 112 after the pressing of the air chamber 102. When the inner end 310 of the conduit 300 is configured to penetrate into the air chamber 102, the inner end 310 of the conduit 300 is located inside the secondary sealing edge 112 after the pressing of the air chamber 102. In addition, a gap is also formed between the inner end 310 of the conduit 300 and the electrode chamber 101. As shown in FIG. 7, only a portion of the air chamber 102 may be pressed to form the secondary sealing edge 112 of the sealed electrode chamber 101.

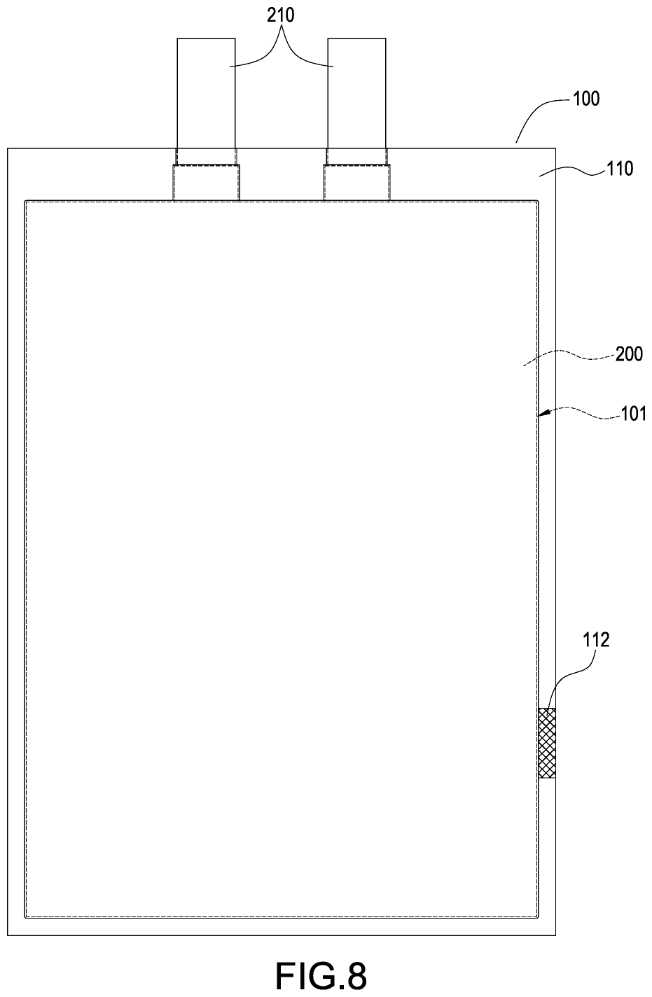

Please refer to FIG. 1 and FIG. 6 to FIG. 9. After the step c), in a cutting step d), the secondary sealing edge 112 is cut off to remove the conduit 300. In addition, the air chamber 102 and the pair of electrode tabs 210 are disposed on different sides of the edge of the outer bag 100 respectively. Accordingly, during the removal of the conduit 300, the electrode tabs 210 may be retained in place without cutting.

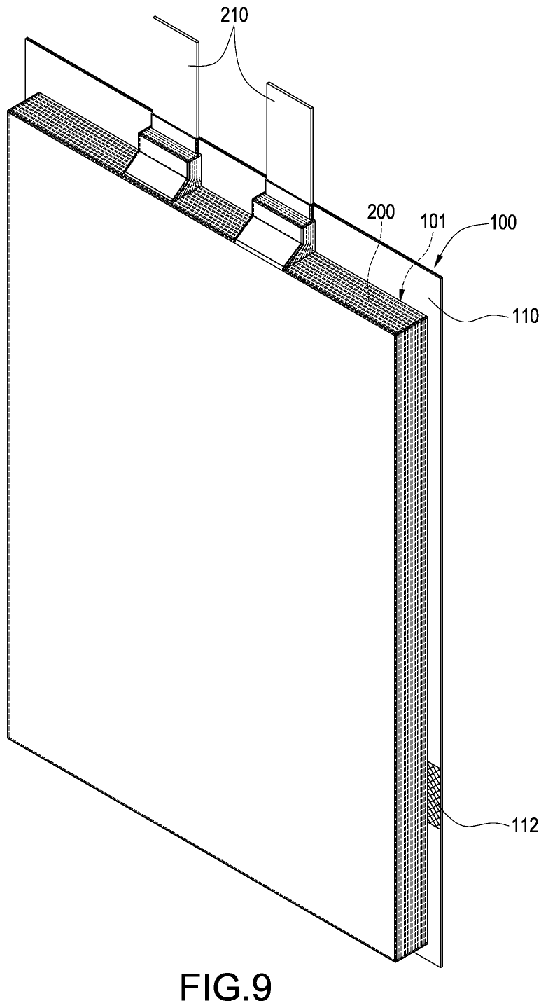

The manufacturing method of a battery cell of this disclosure utilizes the conduit 300 such that the air extraction and fluid injection processes can be facilitated. In addition, after the air chamber 102 is sealed to form the secondary sealing edge 112, the conduit 300 can be removed from the sealing edge 110 completely. For a lithium battery cell, as shown in FIG. 9, manufactured according to the manufacturing method of a battery cell of this disclosure, the sealing edge 110 of such lithium battery cell has a uniform structure, and it is able to avoid the formation of different structures connected to each other, i.e., the outer bag 100 and the conduit 300. Accordingly, when the sealing edge 110 is folded, formation of any slits or gaps between different structures due to concentration of stress may be prevented.

The above is only the feasible embodiments of this disclosure, and not intended to limit the protection scope of this disclosure. Equivalent changes and structural modifications based on the description and drawings of this disclosure should be deemed to be within the protection scope of this disclosure.

What is claimed is:

1. A manufacturing method of a battery cell, the manufacturing method comprising:
a) providing an outer bag, a plurality of electrode plates and a conduit; wherein at least a portion of an edge of the outer bag is pressed to form a sealing edge and an electrode chamber is formed on an inner circumference of the outer bag; the plurality of electrodes are accommodated inside the electrode chamber; the sealing edge is in a strip shape and an air chamber (102) is formed therein, and the air chamber is fluidly communicated to the electrode chamber; the conduit is disposed on the sealing edge, and two ends of the conduit are an inner end and an outer end respectively; the inner end is fluidly communicated to the air chamber, and a gap is disposed between the air chamber and the electrode chamber, and the outer end is exposed from the outer bag;
b) injecting an electrolyte into the electrode chamber via the conduit;
c) pressing the air chamber to form a secondary sealing edge; and
d) cutting the secondary sealing edge to remove the conduit.

2. The manufacturing method of the battery cell according to claim 1, wherein the inner end of the conduit is connected to an edge of the air chamber.

3. The manufacturing method of the battery cell according to claim 1, wherein the air chamber is in a conical shape with a pointed end and a blunt end; the blunt end is connected to the electrode chamber, and the pointed end is connected to the conduit.

4. The manufacturing method of the battery cell according to claim 3, wherein the pointed end of the air chamber is connected to the inner end of the conduit.

5. The manufacturing method of the battery cell according to claim 1, wherein a separation is formed between the air chamber and an outer edge of the sealing edge.

6. The manufacturing method of the battery cell according to claim 1, wherein the sealing edge comprises an air chamber sealing edge formed between the air chamber and an outer edge of the sealing edge, and the conduit is disposed inside the air chamber sealing edge.

7. The manufacturing method of the battery cell according to claim 1, further comprising a step between the step a) and the step b):
e) extracting an air inside the electrode chamber via the conduit.

8. The manufacturing method of the battery cell according to claim 7, wherein in the step e), connecting the outer end of the conduit to a negative pressure device to extract the air inside the electrode chamber.

9. The manufacturing method of the battery cell according to claim 1, wherein in the step b), connecting the outer end of the conduit to a fluid injection device to inject the electrolyte into the electrode chamber.

10. The manufacturing method of the battery cell according to claim 1, wherein in the step c), the conduit is located outside the secondary sealing edge.
